(19) United States
(12) Patent Application Publication
(10) Pub. No.: US 2018/0281120 A1
(43) Pub. Date: Oct. 4, 2018

(54) PIPE CRAWLING WELDING DEVICE AND METHOD OF WELDING PIPES WITH SUCH DEVICE

(71) Applicant: ESAB AB, Goteborg (SE)

(72) Inventor: Arne LAGERKVIST, Göteborg (SE)

(21) Appl. No.: 15/936,719

(22) Filed: Mar. 27, 2018

Related U.S. Application Data
(63) Continuation of application No. PCT/IB2016/056034, filed on Oct. 7, 2016.

(30) Foreign Application Priority Data
Oct. 7, 2015 (EP) PCT/EP2015/073181

(51) Int. Cl. B23K 37/02; B23K 37/053; B23K 9/028

(52) U.S. Cl. CPC B23K 37/0276; B23K 37/0282; B23K 2201/10; B23K 37/0531; B23K 9/0284; B23K 37/0294

(57) ABSTRACT

A pipe crawling welding device including a welding module having a welding head thereon, a mounting shaft, a crawler module and a boom is disclosed. The boom may be fixedly coupled to the mounting shaft. The crawler module may be rotationally coupled to the mounting shaft via, for example, first and second ring bearings so that the crawler module may rotate with respect to the mounting shaft. The welding module may be fixedly coupled to the mounting shaft so that in use, the welding module, boom and mounting shaft may rotate in an opposite direction and at a same rotational speed relative to a direction and rotational speed of the crawler module to maintain an angular position of the welding head.

### CROSS-REFERENCE TO RELATED APPLICATIONS

This is a Continuation of PCT/IB2016/056034 filed on Oct. 7, 2016, which PCT claims the benefit of PCT/EP2015/073181 filed on Oct. 7, 2015, both of which are incorporated by reference herein in their entirety.

### FIELD OF THE DISCLOSURE

Embodiments of the present disclosure relate generally to the field of welding devices, and more particularly to a pipe crawling device that is adapted to weld pipe segments from the inside.

### BACKGROUND OF THE DISCLOSURE

Modern devices for performing submerged arc welding (SAW) within long segments of pipe often employ welding heads that are mounted on large, cantilevered static booms that are adapted to extend deep into pipe segments that are to be welded from the inside. For example, in order to weld two segments of pipe together in an axially abutting relationship, the boom of a conventional SAW device is extended longitudinally entirely through one of the pipe segments in order to position a welding head adjacent a joint between the abutting segments. It is therefore necessary for the boom to be at least as long as, or nearly as along as, the shorter of the two pipe segments to reach the joint.

SAW devices of the type described above are associated with a number of shortcomings. For example, the booms of such devices are generally quite long (e.g., over 10 meters), and therefore require a great deal of floor space within an operating environment, such as in a manufacturing facility, onboard a vessel, or in other settings in which space is at a premium. Furthermore, these types of SAW devices (booms) are generally very heavy (e.g., over 5000 kg), which can be disadvantageous in certain operating environments, such as in a manufacturing facility where the weight of the SAW device may require a custom built floor to handle the weight and momentum of the SAW device. Still further, these types of devices can only be used with a certain length of pipe because the booms bend under their own weight and the weight of the welding head, which can cause alignment problems and in worst cases mechanical and/or plastic deformation.

In view of the forging, it would be desirable to provide a SAW device for welding the interiors of elongated pipe segments wherein such device is relatively compact, lightweight, and inexpensive. It would further be desirable to provide such a SAW device that is not susceptible to significant vibration during a welding operation.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments of the present disclosure are generally directed to a pipe crawling welding device. One exemplary embodiment of the pipe crawling welding device may include a crawler module having a propulsion unit configured to controllably drive the device longitudinally through a pipe. The device may further include a welding module that is rotatably coupled to the crawler module and has a welding head mounted thereon, wherein the welding module and hence the welding head mounted thereon automatically rotates in an opposite direction and at a same rotational speed relative to a direction and rotational speed of the crawler module to maintain an angular position of the welding head.

A method for operating the pipe crawling welding device of the present disclosure may include positioning a welding head of the device adjacent an annular joint between axially abutting first and second pipes, securing a crawler module of the device against rotational movement relative to the first pipe, activating the welding head, rotating the first and second pipes at a first speed and in a first direction about a common axis, and rotating the welding head about the common axis at a second speed that is equal to the first speed and in a second direction that is opposite the first direction to maintain an angular position of the welding head.

### BRIEF DESCRIPTION OF THE DRAWINGS

By way of example, specific embodiments of the disclosed device will now be described, with reference to the accompanying drawings, in which:

FIG. 1 is a perspective view illustrating an exemplary pipe crawling welding device in accordance with the present disclosure;

FIG. 2 is side view of a roller unit of the pipe crawling welding device shown in FIG. 1;

FIG. 3 is perspective detail view illustrating a roller unit of the pipe crawling welding device shown in FIG. 1;

FIG. 4 is perspective detail view illustrating a welding module of the pipe crawling welding device shown in FIG. 1;

FIG. 5 is front perspective detail view illustrating a rotational coupling between a welding module and a crawler module of the pipe crawling welding device shown in FIG. 1;

FIG. 6 is rear perspective detail view illustrating a rotational coupling between a welding module and a crawler module of the pipe crawling welding device shown in FIG. 1;

FIG. 7 is side view illustrating the pipe crawling welding device of FIG. 1 connected to various material, power, and data communication feeds;

FIG. 8 is a flow diagram illustrating an exemplary method of using the pipe crawling welding device shown in FIG. 1;

FIGS. 9a-d are a series of schematic views illustrating several of the method steps set forth in the flow diagram of FIG. 8.

FIG. 10 is a cross sectional side view illustrating the pipe crawling welding device of FIG. 1 with an optional clamping module attached to the crawler module.

FIG. 11 is a partial, side view illustrating an alternate exemplary pipe crawling welding device in accordance with the present disclosure located within first and second pipe sections;

FIG. 12 is a partial, cross-sectional view of the pipe crawling welding device shown in FIG. 11;

FIG. 13 is a partial side view of the pipe crawling welding device shown in FIG. 11, including a motor driven rack and pinion mechanism for coupling the boom to the crawler unit;

FIG. 14A is a frontal perspective view of the crawler module in FIG. 11;

FIG. 14B is a rearward perspective view of the crawler module in FIG. 11;

FIG. 14C is a cross-sectional view of the crawler module taken along line 15C-15C in FIG. 14B;

FIG. 15A is a partial side view of the pipe crawling welding device in FIG. 11, including the motor, rack and pinion;

FIG. 15B is a partial side view of the pipe crawling welding device in FIG. 11 with the crawler module removed;

FIGS. 16A-16H are a plurality of views illustrating the pipe crawling welding device in use;

FIG. 17 is a partial cross sectional view of the pipe crawling welding device shown in FIG. 11 with a support and an angular adjustment mechanism located at a first end thereof;

FIG. 18 is a cross sectional side view illustrating the pipe crawling welding device of FIG. 11 with a view of an optional alternate embodiment of a clamping module.

### DETAILED DESCRIPTION

A device and method in accordance with the present disclosure will now be described more fully hereinafter with reference to the accompanying drawings, in which preferred embodiments of the device and method are shown. The disclosed device and method, however, may be embodied in many different forms and should not be construed as being limited to the embodiments set forth herein. Rather, these embodiments are provided so that this disclosure will be thorough and complete, and will fully convey the scope of the device and method to those skilled in the art. In the drawings, like numbers refer to like elements throughout.

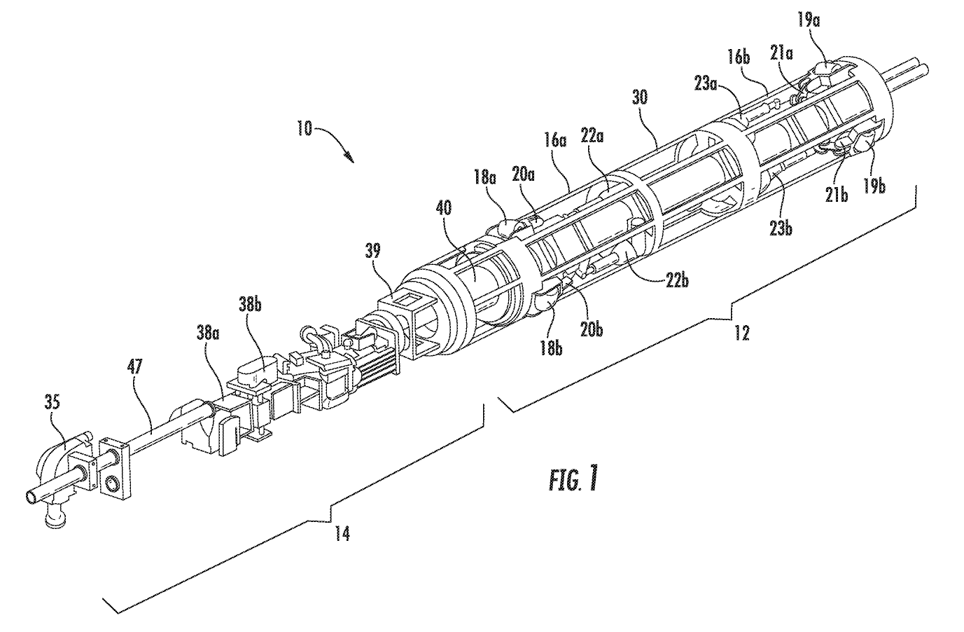

Referring to FIG. 1, an exemplary embodiment of a pipe crawling welding device 10 (hereinafter “the device 10”) in accordance with the present disclosure is shown. For the sake of convenience and clarity, terms such as “front,” “rear,” “top,” “bottom,” “upper,” “lower,” “vertical,” “horizontal,” “lateral,” “longitudinal,” “height,” and “width” may be used herein to describe the relative placement and orientation of the device 10 and its various components, each with respect to the geometry and orientation of the device 10 as it appears in FIG. 1. Particularly, the longitudinal end of the device 10 nearer the lower left corner of FIG. 1 shall be referred to as the “front” of the device and the longitudinal end of the device nearer the upper right corner of FIG. 1 shall be referred to as the “rear” of the device. Said terminology will include the words specifically mentioned, derivatives thereof, and words of similar import.

As shown in FIG. 1, the device 10 may include a generally cylindrical crawler module 12 that is rotatably coupled at its front end to a welding module 14 as further described below. The device 10 may have a size and shape that are suitable for insertion longitudinally into a pipe section that is to be welded. For example, the device 10 may have a largest outer diameter in a range between 100-500 millimeters to accommodate most internal welding applications, though it is contemplated that the device 10 may be made smaller or larger (e.g., having a largest outer diameter up to or exceeding 1500 millimeters) to suit other welding applications without departing from the scope of the present disclosure.

The crawler module 12 may be provided with roller units 16a, 16b located adjacent the front and rear ends of the crawler module 12, respectively. The roller units 16a, 16b may be adapted to concentrically center the device 10 within a pipe section while allowing the device 10 to move longitudinally through the pipe as further described below. The roller units 16a, 16b may be provided with respective sets of positioning wheels 18a, 18b, 18c and 19a, 19b, 19c, wheel arms 20a, 20b, 20c and 21a, 21b, 21c, and drive mechanisms 22a, 22b, 22c and 23a, 23b, 23c. Wheels 18c, 19c, wheel arms 20c, 21c, and drive mechanisms 22c, 23c are not within view but are substantially identical to respective positioning wheels 18a, 18b, 19a, 19b, wheel arms 20a, 20b, 21a, 21b, and drive mechanisms 22a, 22b, 23a, 23b.

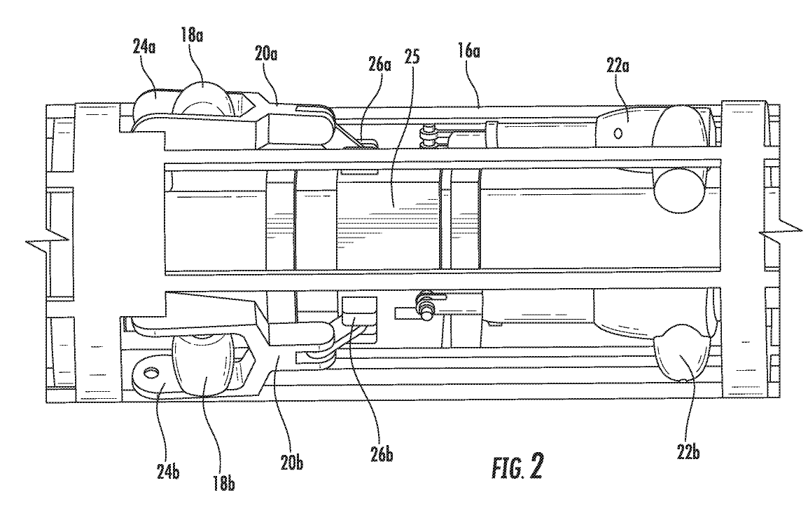

A detail view of the roller unit 16a is shown in FIG. 2. The roller unit 16b is substantially identical to the roller unit 16a, and it will therefore be understood that the following description of the roller unit 16a and its components shall apply equally to the roller unit 16b.

The wheel arms 20a-c of the roller unit 16a may be evenly spaced about a circumference of the crawler module 12 (or about an imaginary circumference of the crawler module 12 if the crawler module 12 does not have a circular cross section). The wheel arms 20a-c may have respective first ends 24a, 24b, 24c that may be pivotably coupled to a static frame portion 25 of the roller unit 16a. The positioning wheels 18a-c may be rotatably mounted to respective second ends 26a, 26b, 26c of the wheel arms 20a-c. The wheel arms 20a-c may be coupled to respective drive mechanisms 22a-c which may be adapted to controllably pivot the wheel arms 20a-c about their respective points of attachment to the frame portion 25, thereby selectively moving the positioning wheels 18a-c radially outwardly or inwardly relative to the frame portion 25. The positioning wheels 18a-c may thereby be controllably moved radially into and out of engagement with the interior surface of a pipe section as will be further described below. The drive mechanisms 22a-c may be any appropriate type of drive mechanisms that are suitable for controllably pivoting the wheel arms 20a-c, including, but not limited to, electric actuators, pneumatic actuators, and hydraulic actuators.

While the exemplary roller units 16a, 16b are shown in FIG. 1 as having three sets of positioning wheels 18a-c, 19a-c, wheel arms 20a-c, 21a-c, and drive mechanisms 22a-c, 23a-c, it is contemplated that the roller units 16a, 16b may be provided with additional sets of wheel arms, positioning wheels, and drive mechanisms without departing from the present disclosure. It is further contemplated that one or both of the roller units 16a, 16b may alternatively be provided with only a single drive mechanism that is adapted to simultaneously drive all of the respective wheel arms 20a-c, 21a-c. Moreover, while the crawler module 12 is shown in FIG. 1 as having two roller units 16a, 16b located adjacent the front and rear ends of the crawler module 12, it is contemplated that crawler module 12 may alternatively be provided with a greater or fewer number of roller units located at a variety of different positions along the crawler module 12.

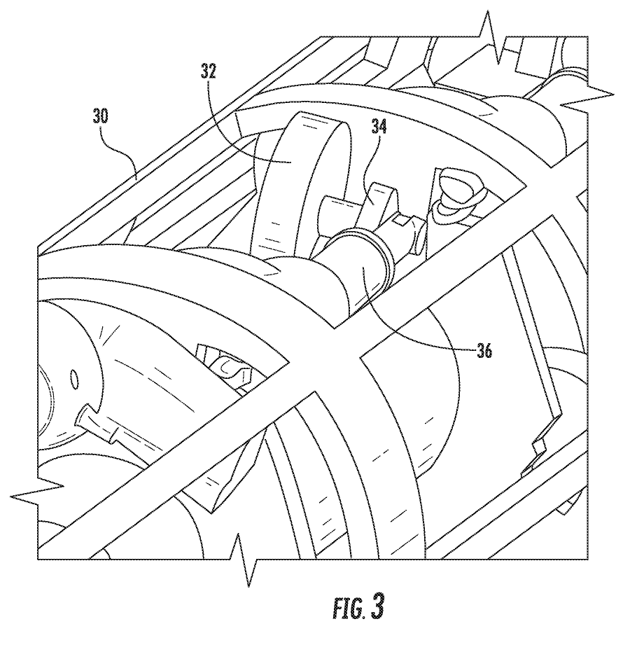

Referring again to FIG. 1, the crawler module 12 may include a propulsion unit 30 located intermediate the roller units 16a, 16b. The propulsion unit 30 may be adapted to controllably drive the device 10 longitudinally through a pipe section. For example, referring to the detailed view of the propulsion unit 30 shown in FIG. 3, the propulsion unit 30 may include a rotatably driven drive wheel 32 that may be mounted to a wheel arm 34. The wheel arm 34 may be coupled to a drive mechanism 36 for radially extending and retracting the wheel arm 34 relative to a static frame portion 37 of the propulsion unit in a manner similar to the wheel arms 20a-c described above. The drive wheel 32 may thereby be moved into and out of contact with the interior of a pipe section as will be further described below. The drive wheel 32 may be provided with a high-friction tread surface, such as may be formed of textured rubber or metal, for establishing a firm grip on the interior of a pipe section. The drive wheel 32 may further be provided with a brake mechanism (not shown) or a brake pad that may be controllably actuated for preventing unintended rotation of the drive wheel 32 to secure the longitudinal position of the device 10 within a pipe section.

The drive wheel 32 and the drive mechanism 36 of the propulsion unit 30 may be driven by electrical motors, compressed gas, etc., wherein the necessary electricity and/or gas may be supplied from sources (e.g., batteries, compressed gas cylinders, etc.) located onboard or external to the crawler module 12.

While the crawler module 12 is shown as having a single propulsion unit 30 with a single drive wheel 32 and wheel arm 34, it is contemplated that the crawler module 12 may be provided with additional propulsion units, and/or that the propulsion unit 30 may be provided with additional drive wheels and/or wheel arms without departing from the present disclosure. Additionally, it is contemplated that the drive wheel 32 and/or the wheel arm 34 may be replaced by, or supplemented with, any other type of structure or mechanism that can be adapted to controllably engage the interior of a pipe and forcibly move the device 10 longitudinally therethrough. Such structures and mechanisms may include, but are not limited to, rotatably driven tracks and belts. It is further contemplated that the propulsion unit 30 may be entirely omitted and that one of more of the positioning wheels 18a-c, 19a-c of the roller units 16a, 16b may be rotatably driven to move the device 10 longitudinally through a pipe section.

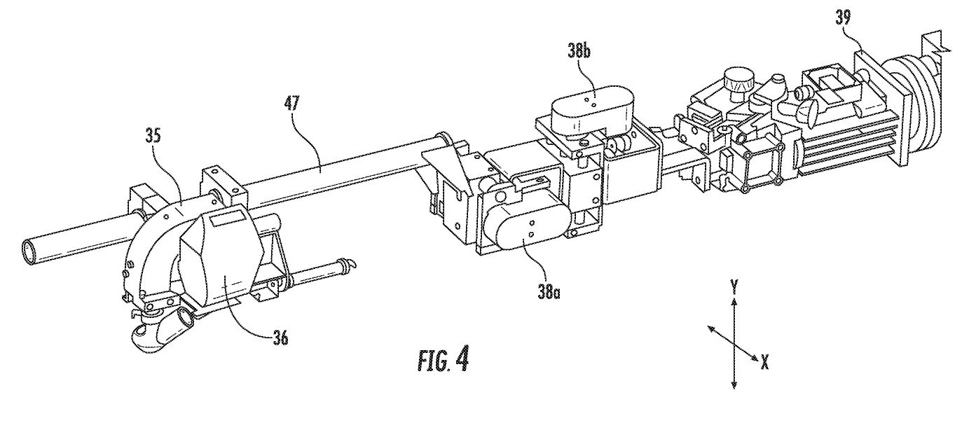

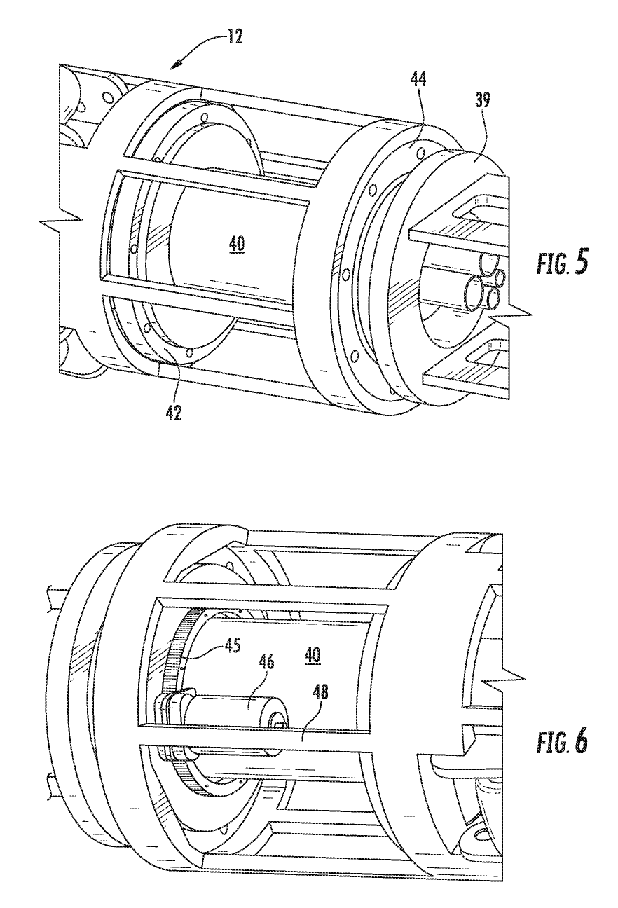

Referring to FIGS. 1 and 4, the welding module 14 of the device 10 may further include a welding head 35, a joint detection unit 36, cross slides 38a, 38b, and a mounting portion 39. As shown in FIG. 5, the mounting portion 39 of the welding module 14 may include a mounting shaft 40 that may be axially coupled to the crawler module 12 by an annular ring bearing 42 such as, but not limited to, roller bearing, rotation bearings, bushings, etc. that allows free rotation of the welding module 14 relative to the crawler module 12 about a common longitudinal axis. The mounting shaft 40 may extend through an annular bearing 43 that is radially interposed between the mounting shaft 40 and a static annular cuff 44 at the front end of the crawler module 12. The mounting shaft 40 may have an outer diameter that is only slightly smaller than an inner diameter of the annular bearing 43, and thus the mounting shaft 40 may extend through the annular bearing 43 in a radially close clearance relationship therewith. The annular bearing 43 may limit radial movement of the mounting shaft 40 and may thereby mitigate vibration of the welding module 14 during operation while allowing free, axial rotation of the mounting shaft 40. It is contemplated that the annular bearing 42 and the annular bearing 43 may be, or may include, any type of suitable mechanical structures that facilitate the above-described rotation and support of the mounting shaft 40. Such mechanical structures include, but are not limited to, roller bearings, ball bearings, bushings, and the like.

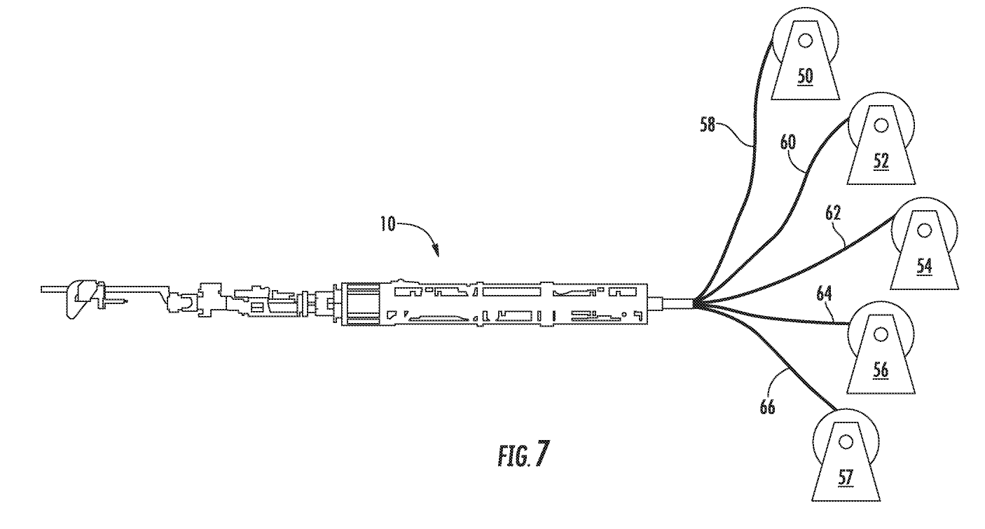

Referring to FIG. 6, a ring gear 45 may be formed or mounted on the mounting shaft 40. A motor 46, such as an electric servo motor, may be mounted to a static frame portion 48 of the front end of the crawler module 12. The motor 46 may be coupled to the ring gear 45 and may be operated to controllably rotate the ring gear 45, mounting shaft 40, and thus the entire welding module 14, relative to the crawler module 12 about a common longitudinal axis. In an exemplary embodiment of the present disclosure, the motor 46 may be coupled to a mechanism or controller that may be configured to automatically operate the motor 46 to rotate the welding module 14 in an opposite direction and at a substantially identical rate of speed relative to a direction and speed of rotation of the crawler module 12. In one contemplated embodiment, the mechanism or controller that dictates the operation of the motor 46 may be, or may include, a gyroscope to sense the angular position of the welding module 14. The motor 46 may thereby maintain an angular position of the welding module 14 regardless of the rotational speed and direction of the crawler module 12 as further described below.

Referring again to FIG. 4, the welding head 35 may be positioned at a front end of the welding module 14. For example, the welding head 35 may be removably mounted on a longitudinally-extending arm 47 at the front of the welding module 14. In one example, the welding head 35 may be a submerged arc welding (SAW) head that is adapted to controllably deliver a consumable electrode and a quantity of flux material to a welding area in a manner that will be familiar to those of ordinary skill in the art. However, it is contemplated that other types of welding heads may be substituted for the SAW head without departing from the present disclosure. Such alternative welding heads may be adapted to perform various welding processes including, but not limited to, metal inert gas (MIG) welding, tungsten inert gas (TIG) welding, flux-cored arc welding (FCAW), plasma arc welding (PAW), etc. While the welding module 14 is shown and described herein as having a single welding head 35, it is contemplated that the welding module 35 may include a plurality of welding heads arranged in a variety of configurations for suiting various applications, including but not limited to, circumferential welding applications and/or longitudinal welding applications as further described below.

The welding head 35 and the arm 37 may be coupled to the mounting portion 39 of the welding module 14 by the cross slides 38a, 38b. In one aspect of the present disclosure, the cross slides 38a, 38b may be substantially identical linear actuators that may be coupled to one another in an offset relationship. The cross slides 38a, 38b may be implemented using virtually any type of controllably-operated actuators, including, but not limited to, electric actuators, pneumatic actuators, and hydraulic actuators. The cross slides 38a, 38b may be operated to effectuate fine movement of the welding head 35 relative to the mounting portion 39 along transverse, respective axes of motion (e.g., the x and y axes shown in FIG. 4). The transverse and vertical positions of the welding head 35 relative to the longitudinal axis of the welding module 14 may thereby be controllably adjusted as further described below. Alternative embodiments of the welding module 14 are contemplated which include a cross slide that is substantially similar to the cross slides 38a, 38b, but that is oriented to facilitate fine longitudinal movement of the welding head 35 along the z axis shown in FIG. 4.

The joint detection unit 36 may be mounted on or adjacent to the welding head 35 and may be configured to detect an interior joint or seem between longitudinally-abutting segments of pipe. The joint detection unit 36 may be implemented using any suitable mechanical, electrical, and/or optical sensor or detector. In one example, the joint detection unit 36 may be, or may include, a video camera which may communicate a recorded image to a remote operator interface as further described below. In other examples, the joint detection unit 36 may be, or may include, a laser or a photodetector which may be adapted to detect a joint. Still further, the joint detection unit may be, or may include, a mechanical seam tracking finger.

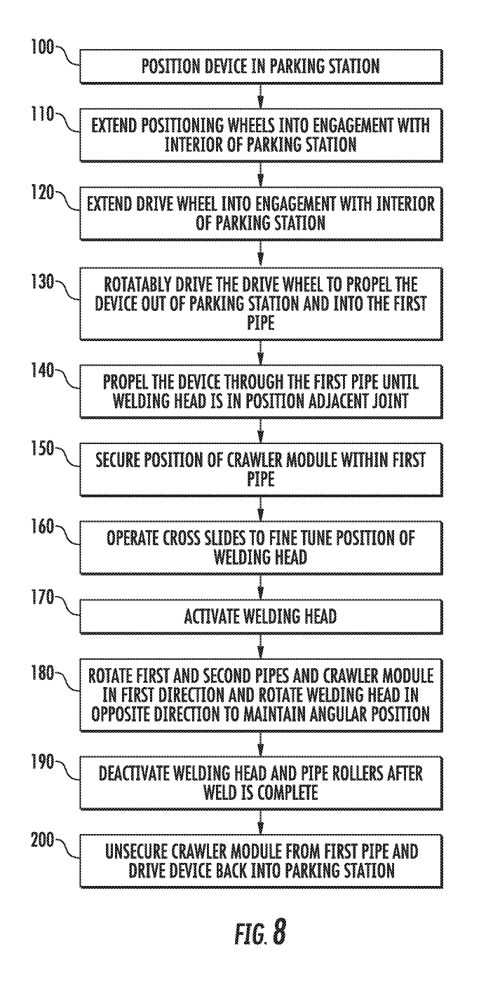

Referring to the side view of the device 10 shown in FIG. 7, a plurality of reels 50, 52, 54, 56, 57 may be located at fixed positions adjacent to one end of the device 10 (e.g., on the floor of a manufacturing facility or on the deck of a vessel). These reels 50-57 may supply the device 10 with consumable materials, control cables, power cables, etc. as the device 10 travels through a pipe as further described below. For example, a first reel 50 may provide the welding head 35 of the device 10 with a consumable electrode 58. A second reel 52 may provide the welding head 35 with a flux supply line 60 through which flux may be delivered to the welding head 35 from a flux container (not shown). A third reel 54 may provide the device 10 with a power line 62 for delivering electrical power to various components of the device 10. A fourth reel 56 may provide the device 10 with a control cable 64 for facilitating control of various components of the device 10 from a controller and/or operator interface (not shown). A fifth reel 57 may provide the welding head 35 with a gas line 66 that may supply gas to a pressurized gas cylinder (not shown) on the device 10 for providing compressed gas to the propulsion unit 30, the cross slides 38a, 38b, and/or other forcibly driven components of the device 10. It is contemplated various additional reels may be similarly implemented for providing the device 10 with various other cables, lines, conductors, wires, and hoses.

Although illustrated as reels, it is contemplated that one or more of the electrode, flux, and compressed gas provided by the above-described reels 50, 52, and 57 may instead be carried onboard the device 10, and that the control features facilitated by the control cable 64 provided by the reel 56 may instead be implemented by onboard components of the device. For example, it is contemplated that the device 10 may carry an onboard supply of electrode and/or flux, thereby eliminating the need for the reels 50 and/or 52.

In some embodiments, the device 10 may include a conduit that extends longitudinally through the crawler module 12 for routing one or more of the above-described cables, lines, conductors, wires, and/or hoses. Such a conduit may house the cables, lines, conductors, wires, and hoses and may mitigate tangling or interference thereof with other components of the device 10. In some embodiments, the conduit may be coupled to the crawler module 12 with bearings so that conduit may remain substantially static while the crawler module 12 rotates during operation of the device 10, thereby mitigating twisting of the cables, lines, conductors, wires, and hoses.

The device 10 may also be provided with a wireless communication module for wirelessly receiving and transmitting command and control signals, thereby eliminating the need for the cable 64 and the reel 56. Exemplary command and control signals include on/off signals for powering the device 10 on or off, jog signals for activating the drive wheel 32 to move the device 10 forward or backward through a pipe, various welding control signals for manipulating the position and operation of the welding head 35, etc. Still further, it is contemplated that the device 10 may be provided with an onboard supply of compressed gas, thereby eliminating the need for the reel 57.

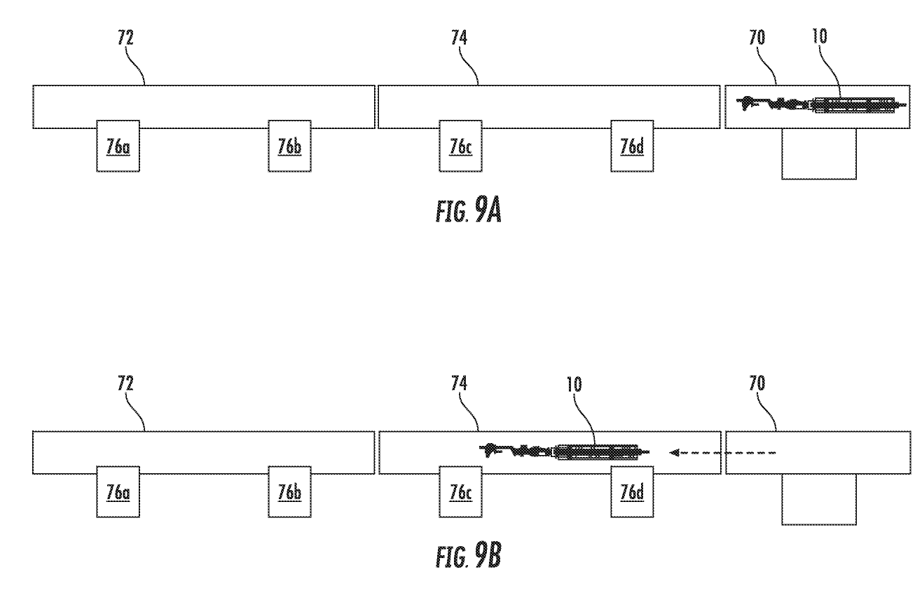

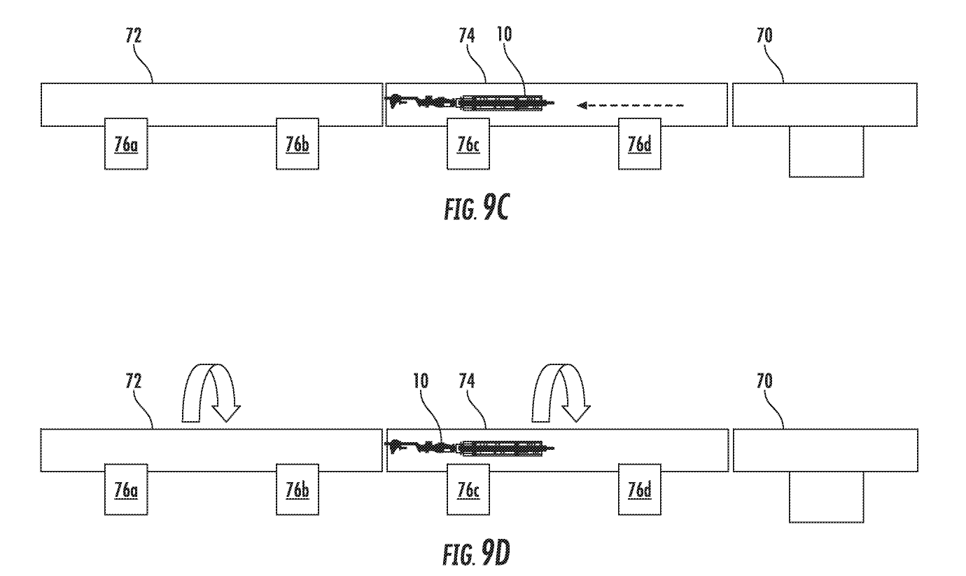

Referring to FIG. 8, a flow diagram illustrating a general exemplary method for operating the device 10 in accordance with the present disclosure is shown. The method will be described in conjunction with the views of the device 10 shown in FIGS. 1-7 and the series of operational steps depicted in FIGS. 9a-9d. Unless otherwise specified, the described method may be effectuated manually at the direction of one or more device operators, and/or automatically at the direction of a properly configured controller, such as through the execution of various software instructions thereby.

At a first step 100, the device 10 may be positioned in a parking station 70 as shown in FIG. 9a with the welding head 35 of the welding module 14 in a 6 o'clock orientation (i.e., directed vertically-downwardly). The parking station 70 may be a section of pipe having a diameter that is substantially equal to the diameters of first and second pipe sections 72, 74 that are to be welded together. The first and second pipe sections 72, 74 may be disposed on pipe rollers 76a, 76b, 76c, and 76d in axial abutment and in concentric alignment with one another and with the parking station 70.

At step 110, the drive mechanisms 22a-c, 23a-c of the roller units 16a, 16b may be operated to radially extend the wheel arms 20a-c, 21a-c as described above, thereby moving the positioning wheels 18a-c, 19a-c into engagement with the interior of the parking station 70 and concentrically centering the device 10 within the parking station 70. At step 120 of the method, the drive mechanism 36 of the propulsion unit 30 may be operated to radially extend the wheel arm 34 as described above, thereby moving the drive wheel 32 into engagement with the interior of the parking station 70.

At step 130, the drive wheel 32 of the propulsion unit 30 may be rotatably driven to propel the device 10 forward through the parking station 70 and into the first pipe 72 as shown in FIG. 9b. The roller units 16a, 16b of the device 10 may allow the device 10 to move smoothly through and between the parking station 70 and the first pipe 72 while maintaining concentric alignment of the device 10 therein. In an alternative embodiment of the exemplary method, the parking station 70 may be omitted and the device 10 may be placed directly into the first pipe 10, such as with a crane or a lift. In such a case, steps 110 and 120 described above would be performed after the device 10 was placed in the first pipe.

At step 140, the propulsion unit 30 may continue to drive the device 10 forward through the first pipe 72 until the welding head 35 of the welding module 14 is moved into longitudinal alignment with, or nearly into longitudinal alignment with, a joint 78 between the first and second pipes 72, 74 as shown in FIG. 9c. The position of the welding head 35 relative to the joint 78 may be manually or automatically determined using the joint detection unit 36 described above. In an alternative embodiment of the exemplary method, the second pipe 74 may be placed on the pipe rollers 76a, 76b in axial abutment and concentric alignment with the first pipe 72 after the welding head 35 has already been moved into a desired welding position at the front edge of the first pipe 72, thereby obviating the need for the joint detection unit 36.

If a desired welding position of the welding head 35 was not or could not been achieved through longitudinal movement of the device 10 by the propulsion unit 30, the cross slides 38a, 38b may, in step 150 of the exemplary method, be operated to effectuate fine lateral and/or vertical movement of the welding head 35 until the desired welding position is achieved. For example, the cross slide 38b may be operated to lower the welding head 35 to a position vertically nearer the joint 78 if necessary. Additionally, or alternatively, the cross slide 38a may be operated to adjust the lateral position of the welding head 35 if necessary.

At step 160, with the welding head 35 still in a 6 o'clock orientation, the drive mechanisms 22a-c, 23a-c of the roller units 16a, 16b may be operated to drive the wheel arms 20a-c, 21a-c radially outwardly to increase the force of the wheels positioning 18a-c, 19a-c against the interior of the first pipe 72, thereby increasing the frictional engagement between the positioning wheels 18a-c, 19a-c and the interior of the first pipe 72 and firmly securing the crawler module 12 against longitudinal or rotational movement relative to the first pipe 72. The drive wheel 32 may additionally or alternatively be forced against the interior of the first pipe 72 in a similar manner to secure the position of the crawler module 12 in the pipe 72. Still further, the brake mechanism of the drive wheel 32 (if the drive wheel 32 is provided with a brake mechanism) may also be employed to prevent rotation of the drive wheel 32 to secure the longitudinal position of the crawler module 12 within the first pipe 72.

At step 170, the welding head 35 may be activated to establish an electrical arc between an electrode and the joint 78 and to deposit a desired quantity of flux on the joint 78 to cover the electrical arc. The welding head 35 may thereby begin to deposit weld metal in the joint 78.

At step 180 of the exemplary method, the pipe rollers 76a-d may be activated to rotate the first and second pipes 72, 74 in the same direction and at a substantially identical speed as shown in FIG. 9d. With the position of the crawler module 12 firmly secured relative to the first pipe 72 as described in step 160 above, the crawler module 12 may rotate with the first pipe 72 as the first pipe 72 is rotated by the pipe rollers 76c, 76d. At the same time, the motor 46 coupled to the ring gear 45 of the mounting shaft 40 of the welding module 14 (shown in FIG. 6) may be activated to automatically rotate the welding module 14 at substantially the same speed but in an opposite direction relative to the crawler module 12 (as described above), thereby keeping the welding head 35 in the 6 o'clock orientation above the joint 78. Thus, as the first and second pipes 72, 74 are rotated, the annular joint 78 rotates and passes below the stationary, active welding head 35 which deposits weld metal in the joint 78 that axially joins the first and second pipes 72, 74.

Once the welding head 35 has completed the weld between the first and second pipes 72, 74 (such as may be automatically or manually determined using the joint detection unit 36, for example), the welding head 35 and the pipe rollers 76a-d may, at step 190 of the exemplary method, be deactivated. At step 200 of the method, the crawler module 12 may be unlocked from the first pipe 72 and the device 10 may be driven back into the parking station 70 by reversing the operations performed in steps 110-140 described above.

Although the method has been described in relation to the making of a circumferential weld between a pair of opposing pipe sections, it is contemplated that the device 10 may also be used to create a longitudinal weld seam within a pipe. For example, the welding head 35 may be activated while the device 10 is driven longitudinally through a pipe as described in steps 110-140 above, with the precise position of the welding head 35 being adjusted as described in step 150 above so as to maintain the welding head 35 in the 6 o'clock position above the joint 78. It is further contemplated that the device 10 may be configured to exclusively perform longitudinal welding. For example, the welding module 14 may be statically (i.e., non-rotatably) coupled to the crawler module 12 in a manner that does not allow relative axial rotation there between. Such an embodiment may be lighter, simpler (i.e., requiring fewer and/or less complex parts), and less expensive to manufacture relative to the embodiment of the device 10 described above, making it more appropriate for applications in which circumferential weld seems are unnecessary.

Referring to FIG. 10, a cross sectional side view of an alternative embodiment of the device 10 is shown in which an optional pipe clamping module 80 is attached to the crawler module 12. The pipe clamping module 80 may be implemented for providing pipe sections, such as pipe sections 82, 84 shown in FIG. 10, with radial support adjacent a longitudinal juncture 86 of the pipe sections 82, 84 when the pipe sections 82, 84 are welded together at the juncture 86.

The pipe clamping module 80 may include a generally cylindrical proximal support cage 88 that may be removably or permanently attached to the static frame portion 48 of the crawler module 12, such as with mechanical fasteners or welds. Alternatively, the pipe clamping module 80 may be integral with the static frame portion 48 of the crawler module 12. The proximal support cage 88 may extend forward from the static frame portion 48 over a majority of the welding module 14 to a forward-most terminus that is longitudinally short of the welding head 35.

The pipe clamping module 80 may further include a generally cylindrical distal support cage 90 that may be coaxial with, and disposed on a longitudinally-opposite side of the welding head 35 from, the proximal support cage 88. The distal support cage 90 may be connected to the proximal support cage 88 by a bridge member 92. The bridge member 92 may longitudinally span, and may be disposed laterally adjacent, the welding head 35. It is contemplated that in some embodiments the bridge member 92 may be attached to the welding head 35. The bridge member 92 may be attached to the proximal support cage 88 and the distal support cage 90 by respective annular ring bearing 94, 96 such as, but not limited to, roller bearings, rotation bearings, bushings, etc. that allow free rotation of the bridge member 92 relative to the proximal support cage 88 and the distal support cage 90 about a common longitudinal axis as further described below.

The pipe clamping module 80 may further include clamping mechanisms 98 that may be integral with the proximal support cage 88 and the distal support cage 90. The clamping mechanisms 98 may include a plurality of circumferentially-spaced pads, tracks, feet or the like that may be radially extended and retracted relative to the proximal support cage 88 and the distal support cage 90, such as via motorized actuation, to selectively engage and disengage the interior surfaces of the pipe sections 82, 84. For example, the clamping mechanisms 98 may be moved between a retracted position, wherein the clamping mechanisms 98 are positioned radially near or within the proximal support cage 88 and the distal support cage 90, and a deployed position (shown in FIG. 10), wherein the clamping mechanisms 98 are radially extended from the proximal support cage 88 and the distal support cage 90 to firmly engage and radially support the pipe sections 82, 84 at positions adjacent the juncture 86. In some embodiments, the pipe clamping module 80 may additionally or alternatively include clamping mechanisms that may be longitudinally extended and retracted, such as for engaging longitudinal ends of pipe sections.

When the device 10 is moved into position to weld the pipe sections 82, 84 together, with the welding head 35 positioned above the juncture 86 as shown in FIG. 10, the clamping mechanisms 98 may be moved to the deployed position to engage and internally clamp the pipe sections 82, 84. When the pipe sections 82, 84 are rotated about their axes during a welding operation (as described above), the proximal support cage 88 and the distal support cage 90 may rotate with the pipe sections 82, 84 by virtue of frictional engagement between the clamping mechanisms 98 and the pipe sections 82, 84. However, since the bridge member 92 is able to rotate freely about its axis relative to the proximal support cage 88 and the distal support cage 90, the bridge member 92 may remain substantially stationary as the pipe sections 82, 84 and the proximal support cage 88 and the distal support cage 90 are rotated. The pipe clamping module 80 may thereby provide the pipe sections 82, 84 with radial support on either longitudinal side of the juncture 86 during a welding operation without the bridge member 92 interfering with the weld head 35.

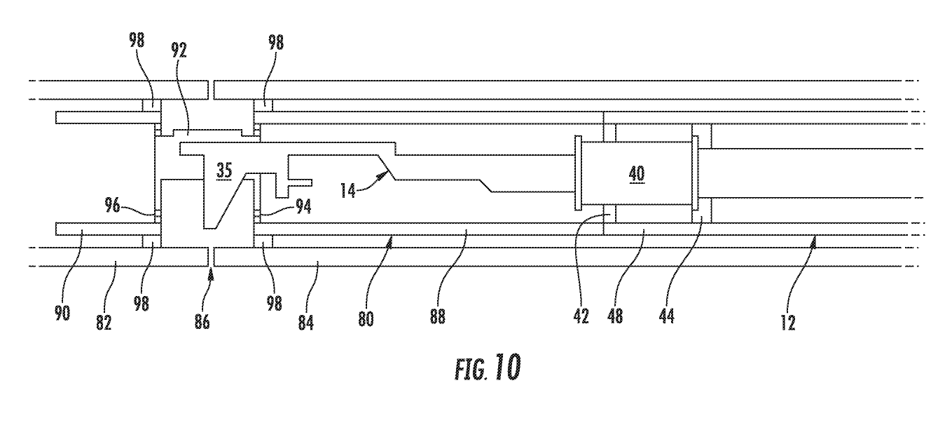

Referring to FIGS. 11-17, an alternative embodiment of the device 100 is shown. The device 100 is substantially identical to device 10 previously described in relation to FIGS. 1-10 except as provided herein.

As shown in FIG. 11, the device 100 may include a boom 102, a crawler unit 112, and a welding module 114. The welding module 114 may be substantially similar to the welding module 14 described above in connection with FIG. 4, and thus for the sake of brevity, the description of the welding module is not repeated here.

Referring to FIGS. 11-13, 16A-16F and 17, the boom 102 may be a cylindrical hollow tube having a first end 104 and a second end 106. It should be noted, that while the boom 102 is shown and described as having a cylindrical outer shape, it is contemplated that the boom 102 can have any shape so long as it fits within the first and second pipe sections 72, 74. The boom 102 may be a single, unitary pipe. Alternatively, the boom 102 may be formed by multiple segments of pipe or may be a telescopic pipe such as, for example, as disclosed in U.S. Pat. No. 8,231,045. The boom 102 may be moved back and forth using, for example, an actuator such as, a cross slide (as previously described) or as described in the '045 patent. The boom 102 has a size and shape that is suitable for insertion into the first and second pipe sections 72, 74 that are to be welded.

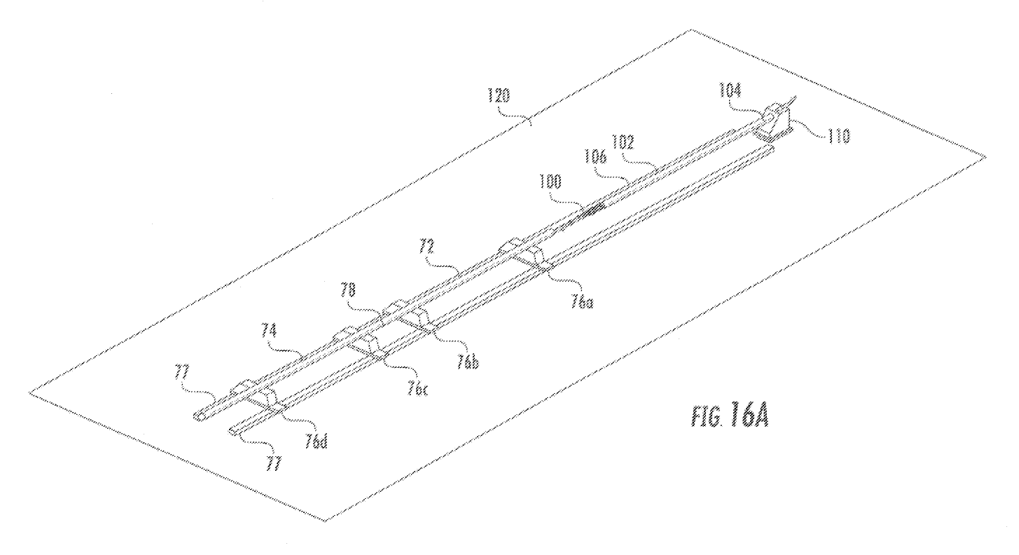

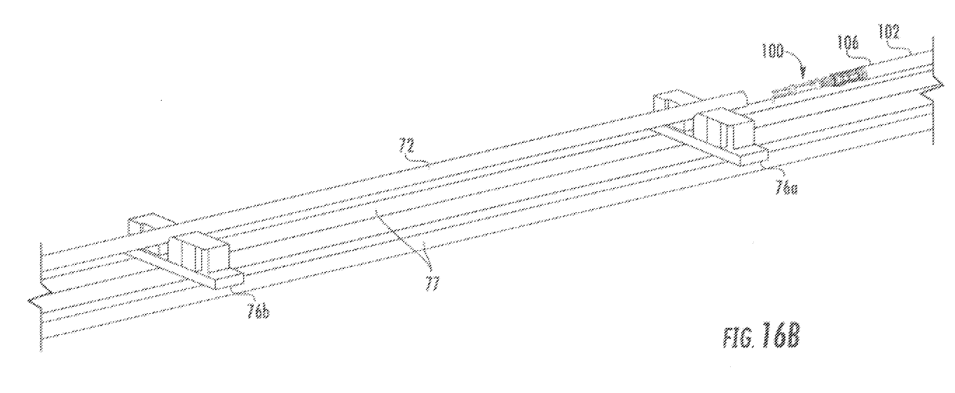

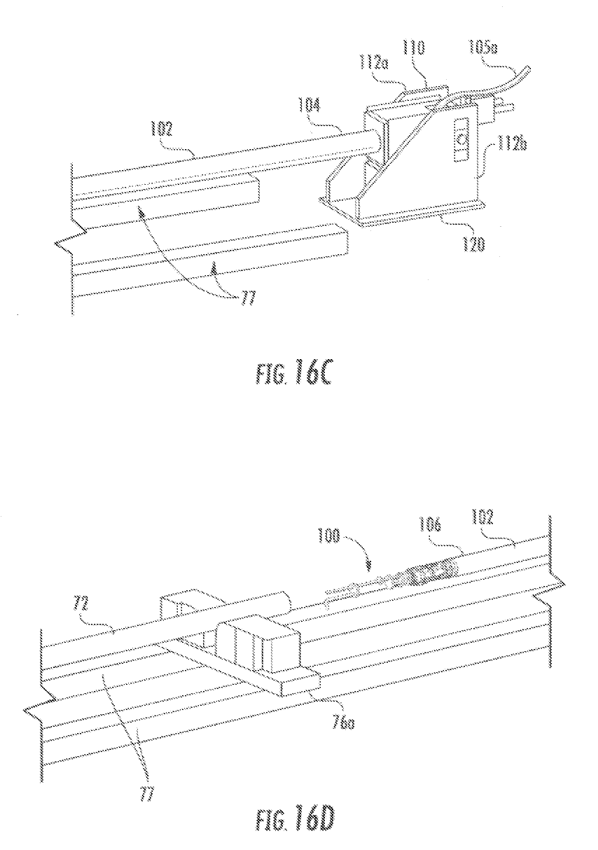

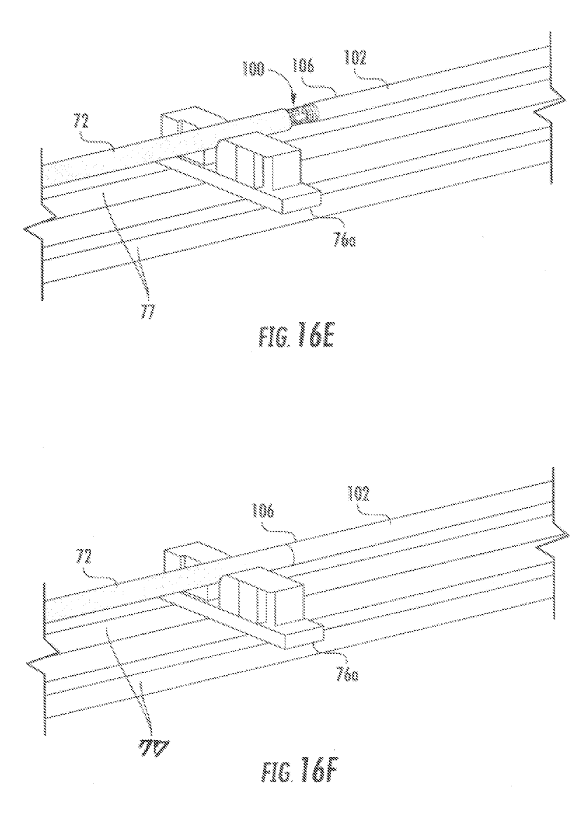

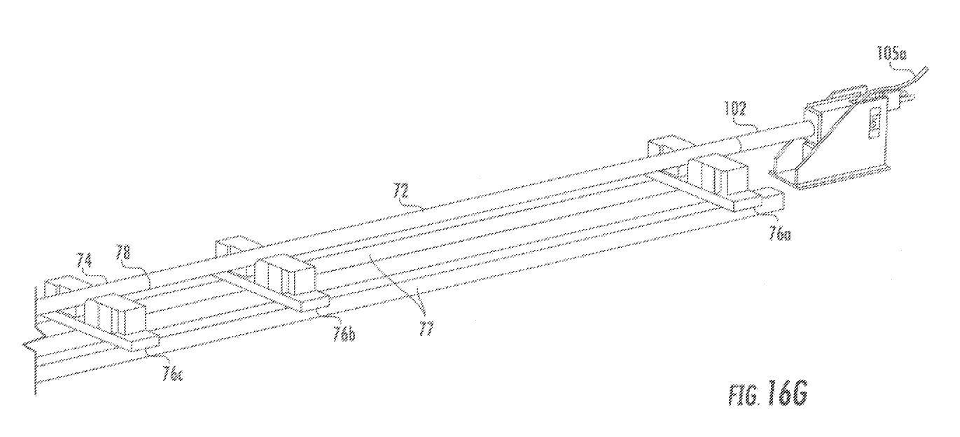

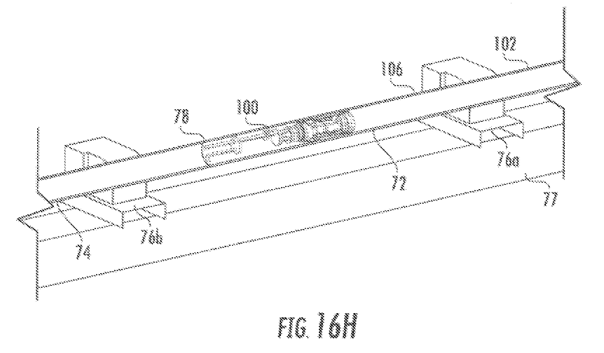

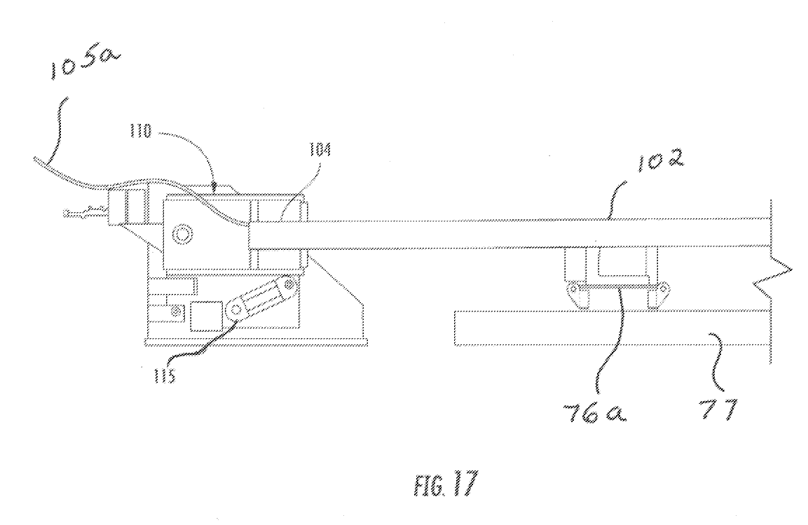

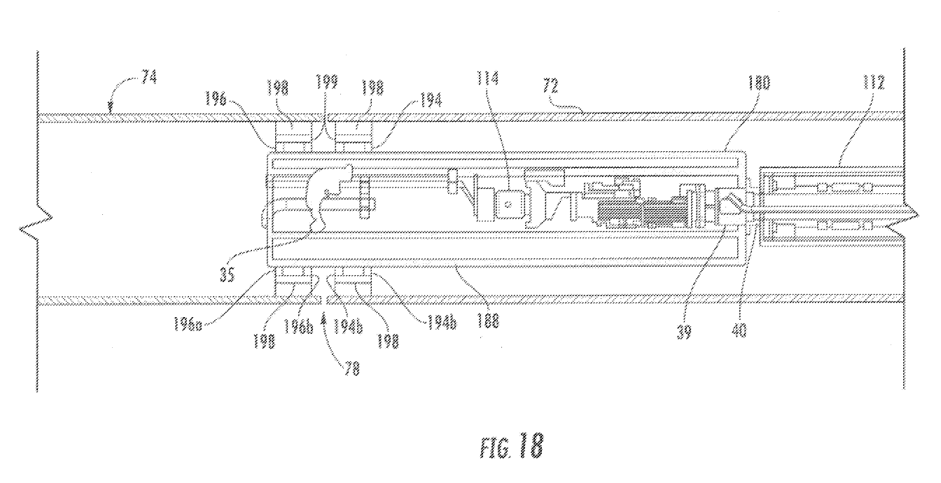

The first end 104 of the boom 102 may be coupled to a support 110 (FIGS. 16A, 16C, 16G and 17). The support 110 may be fixedly coupled to the floor 120 of the operating environment, such as the floor of a manufacturing facility, vessel, etc. In use, the support 110 may be fixably coupled to the boom 102 for supporting the boom 102 in place. As shown, the support 110 may be in the form of a U-shaped bracket 112a, 112b for securing and supporting the boom 102. However, one of ordinary skill in the art will appreciate that the support 110 may take on any form now known or hereafter developed.

As will be described in greater detail below, the support 110 may include an angular adjustment mechanism 115 for angling or tilting the entire boom 102, and hence the device 100 attached thereto. In this manner, the angular adjustment mechanism 115 can angle or tilt the device 100 to offset the elastic deformation of the boom 102. That is, as previously mentioned, the device 100 may be very heavy (e.g., over 5000 kg), which may cause the boom 102 to bend or elastically deform under its own weight and the weight of any equipment attached to it, for example, welding head module 14, etc. By providing an angular adjustment mechanism 115, the user is able to offset some or all of the bend or elastic deformation. The angular adjustment mechanism 115 may provide for up to, approximately 3 degrees of angular adjustment, although it is contemplated that the angular adjustment mechanism 115 may permit more or less adjustment. The angular adjustment mechanism 115 may be any know or hereafter developed mechanism for angularly adjusting the position of the boom 102 and hence the device 100 with respect to the pipe sections 72, 74. For example, the angular adjustment mechanism 115 may be in the form of an actuator (as illustratively shown), an actuator coupled to the boom via a cam gear, etc.

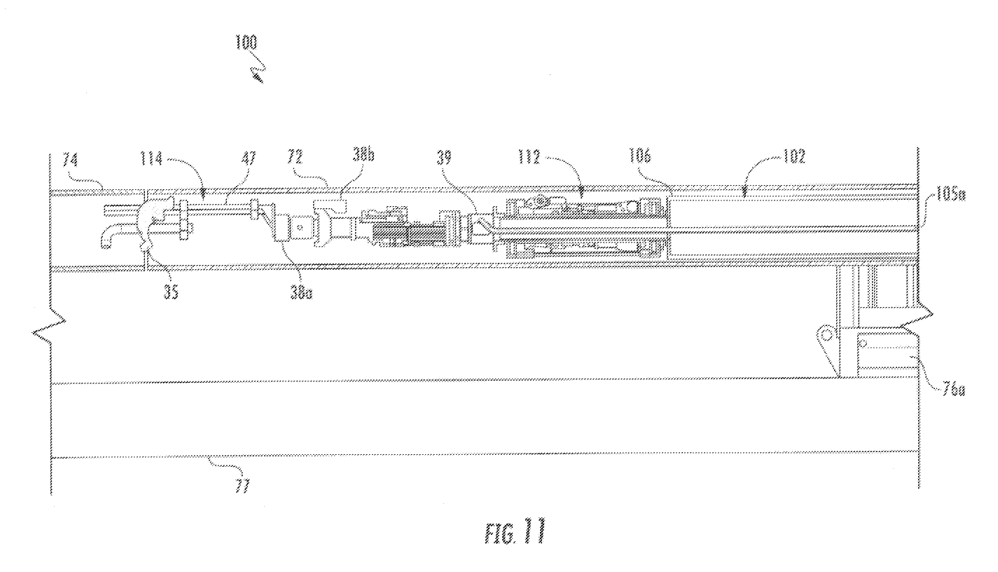

Referring to FIG. 12, the boom 102 may include an internal borehole 105 that extends longitudinally therethrough. As will be described in greater detail below, the mounting shaft 40 may also include an internal borehole 41. The internal boreholes 105, 41 formed in the boom 102 and the shaft 40, respectively, enable routing one or more of the above-described cables, lines, conductors, wires, and/or hoses (illustratively shown as 105a) for serving the welding module 114. In use, the cables, lines, conductors, wires, and/or hoses 105a may extend from the first end 104 of the boom 102 to the second end 106 of the boom, through the mounting shaft 40 attached to the second end 106 of the boom 102, and then to the welding head 35.

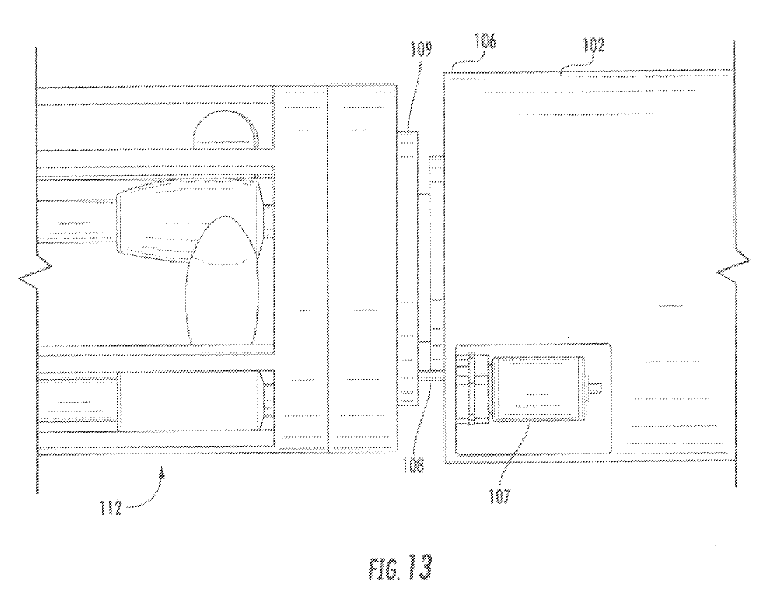

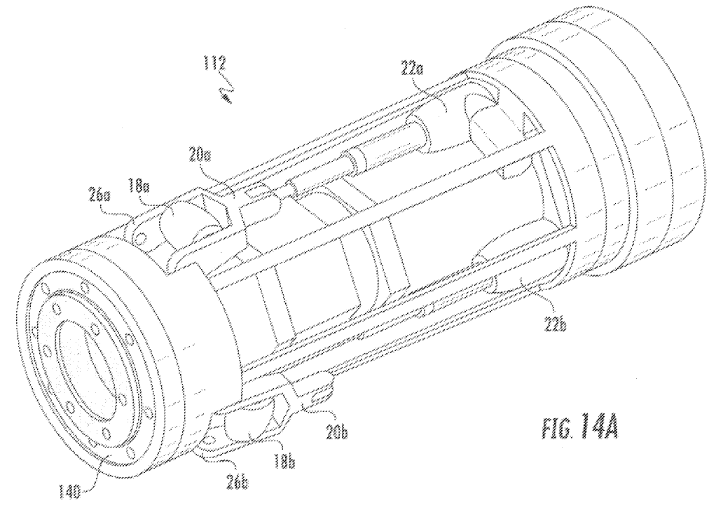

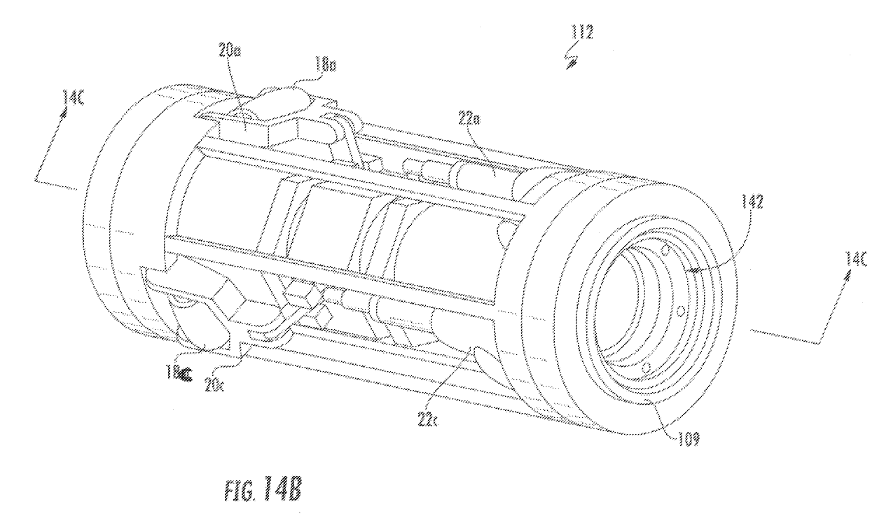

Referring to FIGS. 12 and 14A-14B, the crawler module 112 is shown. The crawler module 112 may be substantially similar to the crawler module 12 previously described in relation to FIGS. 1-10, except as provided herein. For example, the crawler module 112 may be provided with one or more roller units 16a adapted to concentrically center the device 100 within a pipe section while allowing the device 100 to move longitudinally through the pipe. The roller unit 16a may be provided with respective sets of wheels 18a, 18b, 18c, wheel arms 20a, 20b, 20c, and drive mechanisms 22a, 22b, 22c. Wheels 18c, wheel arms 20c, and drive mechanisms 22c, are not within view but are substantially identical to respective wheels 18a, 18b, wheel arms 20a, 20b, and drive mechanisms 22a, 22b. The wheel arms 20a-c may be evenly spaced about a circumference of the crawler module 112 (or about an imaginary circumference of the crawler module 112 if the crawler module 112 does not have a circular cross section). The wheel arms 20a-c may have respective first ends 24a, 24b, 24c that may be pivotably coupled to a static frame portion 25 of the roller unit 16a. The wheels 18a-c may be rotatably mounted to respective second ends 26a, 26b, 26c of the wheel arms 20a-c. The wheel arms 20a-c may be coupled to respective drive mechanisms 22a-c which may be adapted to controllably pivot the wheel arms 20a-c about their respective points of attachment to the frame portion 25, thereby selectively moving the wheels 18a-c radially outwardly or inwardly relative to the frame portion 25. The wheels 18a-c may thereby be controllably moved radially into and out of engagement with the interior surface of a pipe section.

As previously noted, while the exemplary roller unit 16a is shown as having three sets of wheels 18a-c, wheel arms 20a-c, and drive mechanisms 22a-c, it is contemplated that the roller unit 16a may be provided with more or less wheel arms, wheels, and drive mechanisms without departing from the present disclosure. It is further contemplated that the roller unit 16a may alternatively be provided with only a single drive mechanism that is adapted to simultaneously drive all of the respective wheel arms 20a-c. Moreover, while the crawler module 112 is shown as having a single roller unit 16a, it is contemplated that the crawler module 112 may alternatively be provided with a greater number of roller units located at a variety of different positions along the crawler module 112.

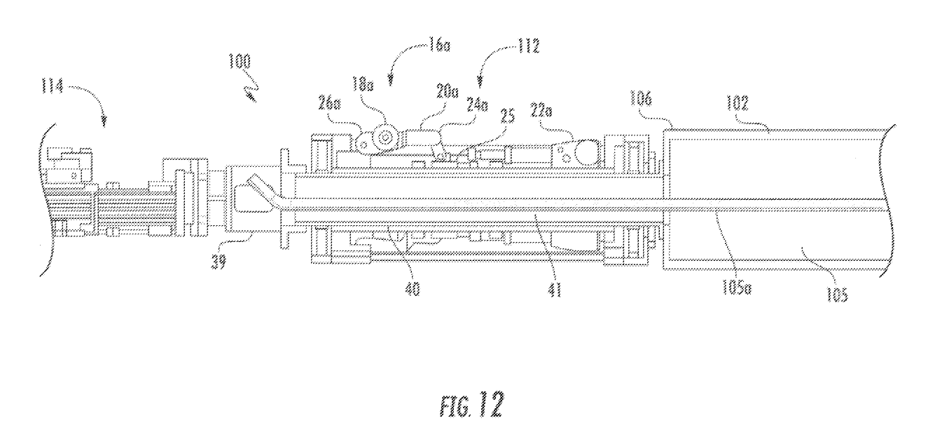

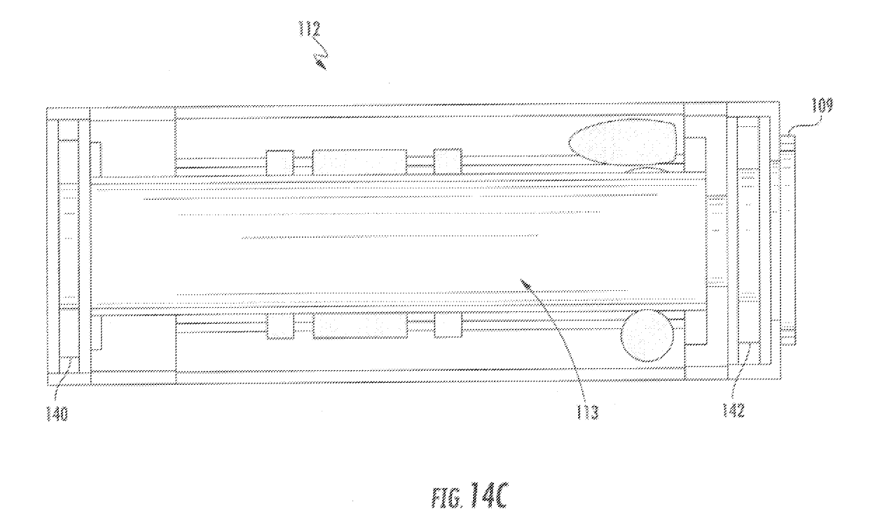

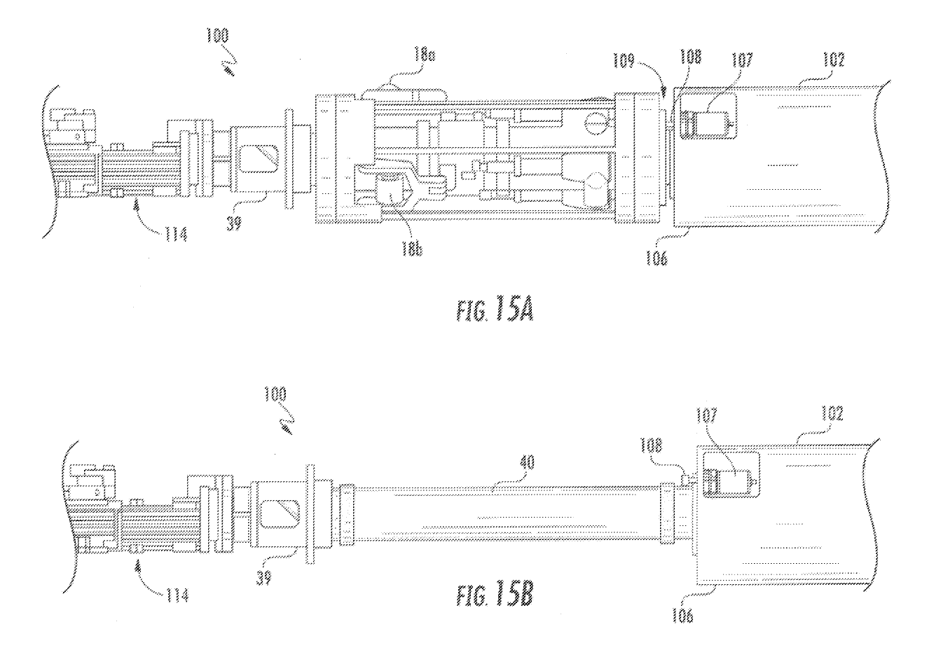

Referring to FIGS. 13, 15A and 15B, the second end 106 of the boom 102 may include a drive motor 107 operatively coupled to a pinion 108 for engaging a rack 109 coupled to the crawler unit 112. In this manner, the crawler unit 112 may be actively, rotatably driven by the motor 107, pinion 108 and rack 109 in synch with the rotation of the pipe sections 72, 74 by the roller beds 76a-d. For example, it may be desirable to utilize the motor 107, pinion 108 and rack 109 to rotate the crawler unit 112 when or if the wheels 18a-c cannot generate enough frictional engagement against the interior surface of the first pipe 72, or, as will be described in greater detail below, when performing a longitudinal weld. A clutch mechanism (not shown) may also be included so that the motor 107, pinion 108 and rack 109 may be disengaged when passive rotation of the crawler unit 112 is sufficient and/or desirable.

Assembling of the device 100 will now be described. Referring to FIGS. 14A-14C, the crawler module 112 may further include first and second ring bearings 140, 142 on opposite longitudinal ends thereof. Furthermore, referring to FIGS. 14C, and 15A-15B, as previously described, the mounting portion 39 of the welding module 114 may include a mounting shaft 40 that may pass through a bore 113 formed in the crawler unit 112 and into mechanical engagement with the second end 106 of the boom 102. The first and second ring bearings 140, 142 may couple the crawler unit 112 to the mounting shaft 40 so that the crawler unit 112 may rotate with respect to the mounting shaft 40 and hence with respect to the boom 102 and welding module 114 coupled thereto. Thus, in use, rotation of the pipe via the pipe rollers 76a-d causes the crawler unit 112 to rotate with respect to the boom 102, mounting shaft 40 and welding module 114. As previously mentioned, the mounting shaft 40 may include a bore 41 (FIG. 12) so that the one or more of the cables, lines, conductors, wires, and/or hoses 105a may extend through the mounting shaft 40 and then to the welding head 35. It is contemplated that the ring bearings 140, 142 may be any type of suitable mechanical structures that facilitate the above-described rotation and support of the mounting shaft 40. Such mechanical structures include, but are not limited to, roller bearings, spherical roller bearings (able to handle angular deviation), rotation bearings, ball bearings, bushings, and the like.

Referring to FIGS. 16A-16G, in use, the first end 104 of the boom 102 is secured to the support 110, which is fastened to the floor 120 of the operating environment so that the boom 102 may be static (although the boom 102 and hence the device 100, which is secured to the second end 106 of the device 100 may be adjusted slightly via the angular adjustment mechanism 115). The pipe sections 72, 74 are placed onto the pipe rollers 76a-d, which reside on rails 77. The pipe rollers 76a-d may be longitudinally translatable along the rails 77 so that the device 100, which is coupled to the second end 106 of the boom 102, may be properly positioned within the pipe sections 72, 74. Once the device 100 is substantially positioned in its proper position, fine adjustment may be made via one or more cross slides that may be incorporated into the welding module 114. The cross-slides may be adapted and configured to provide adjustment in any direction, for example, longitudinally (e.g., along the boom direction), vertically, lateral, etc. The cross slides may enable fine tuning by permitting slight movement of the weld head 114. While it is contemplated that fine tuning may be performed by one or more cross-slides as previously mentioned, it is also contemplated that adjustments may also be performed by moving the entire boom 102, for example, by incorporating a telescopic boom, etc. In this scenario, the entire boom may be moved longitudinally, vertically, and/or laterally by moving the entire boom or by telescopically moving one or more of the boom segments with respect to each other. Thereafter, longitudinal, vertical or lateral adjustment may also be performed by cross-slides.

The device 100 may be positioned to weld either two pipe sections 72, 74 together circumferentially (as shown in FIGS. 16A-16G) or weld one or more pipe sections longitudinally (not shown). When circumferential welding two pipe sections 72, 74 together, the first end 104 of the boom 102 may be secured to the support 110 while the device 100 may be coupled to the second end 106 of the boom 102. Next, the pipe sections 72, 74 may be placed onto the pipe rollers 76a-d, which are movably located on the rails 77. The pipe rollers 76a-d may then be moved longitudinally until the device 100 is properly positioned within the pipe sections 72, 74. Once the desired position has been achieved, the wheels 18a-c may be moved radially into engagement with the interior surface of the pipe section 72. Next, the pipe sections 72, 74 may be rotated in unison via the roller beds 76a-d, the crawler unit 112 may rotate in unison with the rotation of the pipe sections 72, 74 passively due to the wheels 18a-c radially engaging the interior surface of the pipe section 72 and/or in combination with the motor 107, pinion 108 and rack 109, if present, after the wheels 18a-c radially engage the interior surface of the pipe section 72, the crawler unit 112 may be rotatably driven in synch by the motor 107, pinion 108 and rack 109. As such and as previously described above, circular pipe-to-pipe welds are made by positioning the torch of the welding head 35 over the joint 78 between the pipes 72, 74, and rotating the pipe sections 72, 74 as they are being welded together. It should be noted that while the welding process is discussed in terms of welding the pipe section 72, 74 together, it is contemplated that the pipe sections 72, 74 may be initially tack welded together prior to the pipe welding device 100 performing the final weld. The pipe sections 72, 74 may be rotated 360-degrees so that pipe sections 72, 74 may be welded together. While the pipe sections 72, 74 have been described as rotating 360 degrees, it is contemplated that multiple passes may be required and thus the pipe sections 72, 74 may be rotated more than 360 degrees including, for example, 720 degrees, 1080 degrees, etc. As the pipe sections 72, 74 rotate, the torch remains essentially at the 6-o'clock position so that the weld is always made at that position. Thus, in operation the boom 102, the mounting shaft 40 and the welding module 114 remain rotationally fixed, while the pipe sections 72, 74 and the crawler module 112 rotate.

As previously mentioned, the device 100 may further include a pipe clamping module. The device 100 may be used in combination with any clamping module now known or hereafter developed for clamping the first and second pipe sections 72, 74 together. For example, the device 100 may be used with the pipe clamping module 80 illustrated and described above in connection with FIG. 10. Referring to FIG. 18, a side view of an alternative embodiment of an optional pipe clamping module 180 is illustrated. In this embodiment, the pipe clamping module 180 may be attached to the mounting portion 39, the mounting shaft 40 or any other location along the welding module 114 so that the pipe clamping module 180 may be static and non-rotatably coupled to the welding module 114, the mounting shaft 40 and the boom 102. The pipe clamping module 180 may be implemented for providing pipe sections 72, 74 with radial support, and thus alignment, adjacent to the joint 78 between the pipe sections 72, 74 while the pipe sections 72, 74 are welded together.

The pipe clamping module 180 may include a generally cylindrical support cage 188 that may be removably or permanently attached to the mounting shaft 40 of the mounting portion 39, such as with mechanical fasteners or welds. The support cage 188 may extend over a majority of the welding module 114 and extend beyond the joint 78. The support cage 188 may be coupled to the pipe sections 72, 74 by respective ring bearings 194, 196 such as, but not limited to, roller bearings, spherical roller bearings (able to handle angular deviation), rotation bearings, ball bearings, bushings, etc., disposed on longitudinally-opposite sides of the joint 78. The ring bearings 194, 196 allow free rotation of the pipe sections 72, 74 relative to the support cage 188.

The pipe clamping module 180 may further include clamping mechanisms 198. The clamping mechanisms 198 may include a plurality of circumferentially-spaced pads, tracks, feet or the like that may be radially extended and retracted relative to the support cage 188, such as via motorized actuation, to selectively engage and disengage the interior surfaces of the pipe sections 72, 74. For example, the clamping mechanisms 198 may be moved between a retracted position, wherein the clamping mechanisms 198 are positioned radially near or within the support cage 188, and a deployed position (shown in FIG. 18), wherein the clamping mechanisms 198 are radially extended from the support cage 88 to firmly engage and radially support, and thus align, the pipe sections 72, 74 at positions adjacent the joint 78. In some embodiments, the pipe clamping module 180 may additionally or alternatively include clamping mechanisms that may be longitudinally extended and retracted, such as for, aligning and/or engaging longitudinal ends of pipe sections 72, 74.

Referring to FIG. 18, each clamping mechanism 198 is shown as being operatively associated with a pair of ring bearings 194a, 194b, 196a, 196b such as, but not limited to, roller bearings, spherical roller bearings (able to handle angular deviation), rotation bearings, ball bearings, bushings, etc. It is contemplated that each clamping mechanism 198 may be operatively associated with more or less ring bearings. For example, each clamping mechanism 190 may be coupled to the support cage 188 via a single bushing. In addition, as shown, each ring bearing 194, 196 may be coupled to the clamping mechanism 190 via an intermediate member 199, such as, for example, a pipe.

In use, when the device 100 is moved into position to weld the pipe sections 72, 74 together, with the welding head 35 positioned above the joint 78 as shown in FIG. 18, the clamping mechanisms 198 may be moved to the deployed position to engage and internally clamp the pipe sections 72, 74. When the pipe sections 72, 74 are rotated about their axes during a welding operation (as described elsewhere), the support cage 188 remains fixedly static with respect to the welding module 114, mounting shaft 40 and boom 102. The pipe clamping module 180 may thereby provide the pipe sections 72, 74 with radial support, and thus alignment, on either longitudinal side of the joint 78 during a welding operation.

To longitudinally weld one or more pipe(s), the device 100 may be coupled to the second end 106 of the boom 102, while the first end 104 of the boom 102 may be coupled to the support 110. The pipe to be longitudinally weld may be placed onto the pipe rollers, which are movably located on the rails. The pipe rollers may then be moved longitudinally until the device 100 is properly positioned within the pipe. Next, the crawler unit 112 may be properly positioned by utilizing the motor 107, pinion 108 and rack 109. For example, the crawler unit 112 may be positioned such that the boom 102 can be evenly supported by the two lower wheels, e.g. where the top wheel is approximately positioned in the 12 o'clock position. Next, the wheels 18a-c may be moved radially into engagement with the interior surface of the pipe. In this particular situation, the wheels 18a-c may only contact the interior surface of the pipe with moderate pressure to avoid clamping or by only radially expanding the two lower wheels to engage the interior surface of the pipe while the top wheel, which is approximately positioned in the 12 o'clock position, does not contact the interior surface of the pipe. Next, the pipe rollers 76 may be longitudinally translated along the rails. For example, the pipe rollers may be moved so that the pipe rollers 76 move away from the boom 102. With the weld head positioned in the 6 o clock position, as the pipe rollers 76 and hence the pipe moves, the pipe may be longitudinally welded. With longitudinal welding, the system may include a start and stop plate (not shown) extending a distance from the pipe to be welded to give support for the weld flux and make sure the start and end of weld is satisfactory. Upon completion, the start and stop plate may be removed.

The crawler unit 112 provides support for the welding module 114 and hence the welding head 35 by preventing or minimizing oscillation of the boom 102, the mounting shaft 40 and the welding module 114 that occurs with prior systems that incorporate an unsupported boom. With prior art systems that incorporate a simple unsupported boom, the boom can bend and oscillate while the device 100 is performing circumferential or longitudinal welding. Such oscillations can make it difficult or impossible to stabilize the welding head 35 in a manner suitable for obtaining a high-quality weld. This makes the present embodiment particularly beneficial for use with pipe lengths exceeding, for example 10 meters.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. A welding device comprising:
a boom having a first end and a second end;
a crawler module; and
a welding module having a welding head mounted thereon;
wherein the crawler module is rotatable with respect to the boom and welding module such that the boom and the welding module can rotate in an opposite direction and at a same rotational speed relative to a direction and rotational speed of the crawler module to maintain an angular position of the welding head.

2. The welding device of claim 1, wherein the first end of the boom is coupled to a support structure.

3. The welding device of claim 2, wherein the support structure includes an angular adjustment mechanism for angling the boom.

4. The welding device of claim 1, wherein the boom is sized and adapted for insertion into one or more pipe sections.

5. The welding device of claim 1, wherein the boom further includes a motor adjacent to the second end thereof, the motor coupled to a gear on the crawler module, the motor being configured to rotate the crawler module at the same rotational speed and in the opposite direction relative to the boom and welding module.

6. The welding device of claim 1, further comprising a mounting shaft having a first end and a second end, the first end of the mounting shaft being coupled to the welding module, the second end of the mounting shaft being coupled to the second end of the boom.

7. The welding device of claim 6, further comprising first and second ring bearings for coupling the mounting shaft to the crawler module so that the crawler module is rotatable with respect to the mounting shaft, the boom and the welding module.

8. The welding device of claim 1, further comprising:
one or more pipe sections;
a rail; and
a plurality of pipe rollers movably located on the rail and operative to rotate the one or more pipe sections;
wherein the welding device is sized and configured to be inserted into the one or more pipe sections by moving the pipe rollers with respect to the rail.

9. The welding device of claim 1, further comprising a pipe clamping module attached to the welding module so that the pipe clamping module is non-rotatably coupled to the welding module.

10. The welding device of claim 9, further comprising a mounting shaft having a first end and a second end, the first end of the mounting shaft being coupled to the welding module, the second end of the mounting shaft being coupled to the second end of the boom, the pipe clamping module being attached to the mounting shaft.

11. The welding device of claim 9, wherein the pipe clamping module is adapted and configured to provide radial support on either side of a circumferential joint between first and second pipe sections being welded together.

12. The welding device of claim 11, wherein the pipe clamping module includes a support cage, first and second bearings disposed on longitudinally-opposite sides of the joint, the bearings enabling rotation of the first and second pipe sections relative to the support cage.

13. The welding device of claim 11, wherein the pipe clamping module further includes a plurality of clamping mechanisms that are radially extendable relative to the support cage to selectively engage and disengage from an interior surface of the pipe sections.

14. The welding device of claim 13, wherein the plurality of clamping mechanisms are also adapted and configured to longitudinally extendable for engaging longitudinal ends of the pipe sections for longitudinally aligning the joint.

15. A method for welding pipes using a pipe crawling welding device, the method comprising:
securing a first end of a boom associated with the pipe crawling device to a support structure;
placing one or more pipe sections onto a plurality of pipe rollers, wherein the pipe rollers are movably located on a rail;
positioning the pipe crawling welding device into the one or more pipe sections so that a welding head associated with the pipe crawling welding device is properly positioned;
securing a crawler module associated with the pipe crawling welding device against rotational movement relative to the first pipe section;
activating the welding head;
rotating the one or more pipe sections at a first speed and in a first direction about a common axis; and
rotating the welding head about the common axis at a second speed that is equal to the first speed and in a second direction that is opposite the first direction to maintain an angular position of the welding head.

16. The method of claim 15, wherein the pipe crawling welding device is positioned by moving the pipe rollers, and hence the one or more pipe sections, with respect to the rail.

17. The method of claim 15, wherein the welding head is properly positioned when the welding head is located adjacent an annular joint between axially abutting first and second pipe sections.

18. The method of claim 17, wherein the welding head is properly positioned when the welding head is located adjacent a longitudinal joint in a pipe section.

19. The method of claim 18, wherein the welding head is moved longitudinal with respect to the joint by moving the pipe rollers with respect to the rail.

20. The method of claim 15, wherein rotating the one or more pipe sections at a first speed and in a first direction about a common axis is done by rotating the pipe via the pipe rollers.

21. The method of claim 20, wherein rotating the welding head about the common axis at a second speed that is equal to the first speed and in a second direction that is opposite the first direction to maintain an angular position of the welding head is done by a motor, a rack and pinion gear.

22. The method of claim 21, wherein the motor is coupled to the boom and the gear is operatively associated with the crawler unit such that activation of the motor rotates the crawler unit with respect to the boom.
